(19) United States
(12) Patent Application Publication
(10) Pub. No.: US 2012/0081208 A1
(43) Pub. Date: Apr. 5, 2012

(54) APPARATUS FOR OPERATING DOOR OF CONNECTOR CONNECTION PART IN EV CHARGING STAND

(75) Inventor: Chung Woo LEE, Cheongju (KR)

(73) Assignee: LSIS CO., LTD.

(21) Appl. No.: 13/239,276

(22) Filed: Sep. 21, 2011

(30) Foreign Application Priority Data
Oct. 5, 2010 (KR) 10-2010-0096765

(51) Int. Cl. G08B 29/00

(52) U.S. Cl. 340/5.7

(57) ABSTRACT

Disclosed is an apparatus for operating a door of a connector connection part in an EV charging stand, which is configured to control an operation of opening or closing the door of the connector connection part of the EV charging stand to which a connector of an electric vehicle is connected for a charging operation, using ID information of an EV user, and which is advantageous in that the connector connection part of the EV charging stand is prevented from being randomly opened when the electric vehicle is not charged, thus preventing an electric shock accident or damage to the connection part, and an unauthorized user is prevented from using the EV charging stand, thus effectively preventing the electric vehicle from being stolen.

This application claims the benefit of Korean Patent Application No. 10-2010-0096765, filed Oct. 5, 2010, the disclosure of which is hereby incorporated herein by reference in its entirety.

### BACKGROUND OF THE INVENTION

1. Field of the Invention

The present invention relates generally to an apparatus for operating a door of a connector connection part in an electric vehicle (EV) charging stand and, more particularly, to an apparatus for operating a door of a connector connection part in an EV charging stand, configured to control an operation of opening or closing a door of a connector connection part of an EV charging stand to which a connector of the electric vehicle is connected for a charging operation, using identification (ID) information of an EV user.

2. Description of the Related Art

Recently, although oil resources are being exhausted all over the world, oil consumption is increasing rapidly. Thus, there is a trend to suppress use of fossil energy causing much pollution and to develop alternative energy substituting for the fossil energy. According to this trend, research into an electric vehicle supplied with power from electricity has been conducted in place of a vehicle supplied with power from a gasoline engine.

Korean government made a statement about a plan for mass production of an electric vehicle in 2011. Thus, a rapid increase in demand for the electric vehicle is expected. The electric vehicle may be charged in a parking lot of a workplace or home as well as a charging station. It usually takes 4 to 6 hours to charge the electric vehicle once. Moreover, even a quick charging operation requires 30 minutes to 1 hour.

The electric vehicle is driven using electric energy stored in a battery. With a single charging operation, the electric vehicle may travel only about 100 to 150K m. Thus, the battery must be frequently charged during travel.

FIG. 1 is a view illustrating a configuration of an EV charging stand according to the present invention.

Currently, one EV charging stand is configured so that it is provided with a cable-type connector for directly performing a charging operation, like an oil feeder installed in a filling station, so that the connector is put into the connection part of the electric vehicle. Further, the other is configured so that an electric vehicle is provided with a connector for charging the vehicle and an EV charging stand is provided with a connector connection part.

The latter configuration is applied to the EV charging stand according to the present invention, as shown in FIG. 1. Generally, the EV charging stand 100 according to the present invention is provided with a user interface unit 110, and is constructed so that a door 120 of a connector connection part 130 is manually opened or closed. Thus, the door 120 may be undesirably opened. Thereby, the connection part 130 may be undesirably opened even when the electric vehicle is not charged, thus causing an electric shock accident or damaging the connection part. Further, since persons other than an EV user may undesirably use the charging stand, security measures for preventing unauthorized persons from using the connector connection part 130 are required.

### SUMMARY OF INVENTION

Accordingly, an object of the present invention is to provide an apparatus for operating a door of a connector connection part in an EV charging stand, in which the door of the connector connection part is not manually opened or closed randomly, but is automatically opened only when it is approved that an EV user is an authorized user based on received ID information of the EV user.

In one general aspect of the present invention, there is provided an apparatus for operating a door of a connector connection part in an EV charging stand, the apparatus comprising: a user interface unit configured to receive ID information of an EV user; a user identification unit configured to check whether the received ID information matches pre-registered ID information and to output a result of the checking; a control unit configured to receive the output of the user identification unit and to transmit a signal for controlling a door operating unit depending on the result of the checking; and the door operating unit configured to switch the door of the connector connection part in the EV charging stand between an open mode and a close mode in response to the signal transmitted from the control unit. Further, the control unit is configured to transmit an open signal to the door operating unit, when the received ID information matches the pre-registered ID information. The control unit is configured to receive an output of the user identification unit and to display a notification message in the user interface unit to notify mismatch between the received ID information and the pre-registered ID information, when the received ID information does not match the pre-registered ID information.

The door operating unit comprises a solenoid to change a direction of a current flowing through the solenoid in response to the signal transmitted from the control unit, thus opening or closing the door.

The control unit according to the present invention is configured to monitor a connection between a connector of the EV and the connector connection part of the EV charging stand, and to transmit a close signal to the door operating unit when the connector is disconnected from the connector connection part for a predetermined period of time. The control unit is configured to store information on a use of the charging stand and a charged vehicle in an internal memory. The stored information is used for security of a vehicle. The stored information is transmitted through a central management server to each user.

The present invention is advantageous in that a connector connection part of an EV charging stand is prevented from being randomly opened even when an electric vehicle is not charged, thus preventing an electric shock accident or damage to the connection part. Further, the present invention prevents an unauthorized user from using the EV charging stand, thus effectively preventing an electric vehicle from being stolen.

Further, the present invention is advantageous in that it records information about the using of a user who uses an EV charging stand and information about a user's vehicle, thus ensuring the security of a vehicle and allowing each user to see information about the charging of a vehicle.

### BRIEF DESCRIPTION OF THE DRAWINGS

FIG. 1 is a view illustrating a configuration of an EV charging stand according to the present invention;

FIG. 2 is a block diagram illustrating an apparatus for operating a door of a connector connection part in an EV charging stand in accordance with an exemplary embodiment of the present invention;

FIG. 3 is a view illustrating a configuration and an operation of a door operating unit in accordance with the embodiment of the present invention; and

FIG. 4 is a flowchart showing a process of opening or closing the door of the connector connection part in the EV charging stand in accordance with the embodiment of the present invention.

### DETAILED DESCRIPTION OF THE INVENTION

It should be understood that the embodiment shown in the accompanying drawings is for illustrative purposes only. Further, the embodiment is provided for the purpose of most easily describing the principle and concept of the present invention.

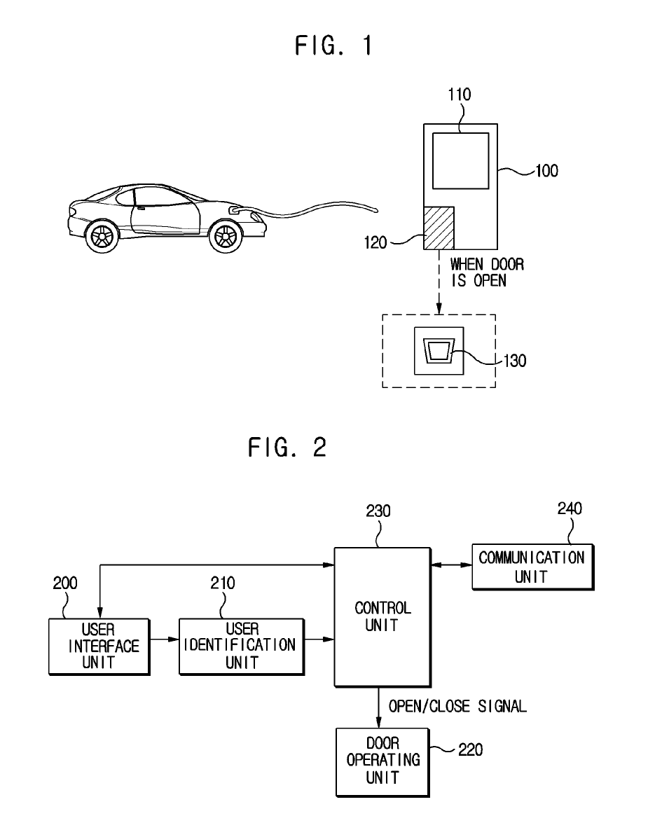

FIG. 2 is a block diagram illustrating an apparatus for operating a door of a connector connection part in an EV charging stand in accordance with an exemplary embodiment of the present invention.

The door operating apparatus according to the present invention may include a user interface unit 200, a user identification unit 210, a door operating unit 220, a control unit 230, and a communication unit 240.

The user interface unit 200 is configured to receive ID information of an EV user, and comprises a user-ID-card reader or a keypad as one example.

The user identification unit 210 is provided with a database storing ID information on persons registered as an EV user. Further, the user identification unit 210 is configured to compare ID information received from the user interface unit 200 with information stored in the database, to check whether the received ID information matches the ID information stored in the database, and then to output the result of the checking.

The door operating unit 220 is a kind of switch, and is a component that switches the door of the connector connection part of the EV charging stand between an open mode and a close mode, in response to a signal transmitted from an outside.

The control unit 230 receives the output of the user identification unit 210, and transmits an open signal to the door operating unit 220 when the user identification unit 210 determines that the received ID information matches the information of the database. In contrast, if the user identification unit 210 determines that the received ID information does not match the information of the database, the control unit 230 displays a notification message in the user interface unit 200 to notify that the received ID information does not match the information of the database, and does not output an open signal. Thereby, it is controlled that only a registered user may charge an electric vehicle and an unregistered person may not charge an electric vehicle, thus preventing an electric vehicle from being stolen and ensuring safe use and charging of an electric vehicle.

The communication unit 240 is configured to perform data communication between the EV connector and the connector connection part of the EV charging stand when the EV connector is connected to the connector connection part.

The control unit 230 may collect information on time when a user starts and finishes using the charging stand, charging time, etc. via the communication unit 240. The control unit 230 records the collected information on a use of the charging stand and a user's vehicle, so that the recorded information can be used for security of a vehicle. Further, the control unit 230 records the information, thus transmitting the use information through a central management server to each user and allowing the user to see information on the charging of a vehicle.

Further, the control unit 230 periodically monitors a connection between the EV connector and the connector connection part of the EV charging stand, through the communication unit 240. From the communication unit 240, the control unit 230 receives a pilot signal informing that a connection between the connector and the connector connection part is made, and thereafter receives a pilot signal informing that a disconnection between the connector and the connector connection part is made. Thereafter, unless the pilot signal informing that the connector and the connector connection part are connected to each other again is transmitted for a preset period of time, a close signal is transmitted to the door operating unit 220. The door operating unit 220 switches to close the door of the connector connection part if the close signal of the control unit 230 is inputted. That is, the control unit 230 performs control such that the door of the connector connection part is automatically closed, if a user disconnects the EV connector from the connector connection part of the charging stand after the electric vehicle has been charged.

Here, the switching operation of the door operating unit 220 for opening or closing the door may be performed using a solenoid. That is, a direction of a current flowing through the solenoid is changed in response to a signal transmitted from the control unit, thus opening or closing the door.

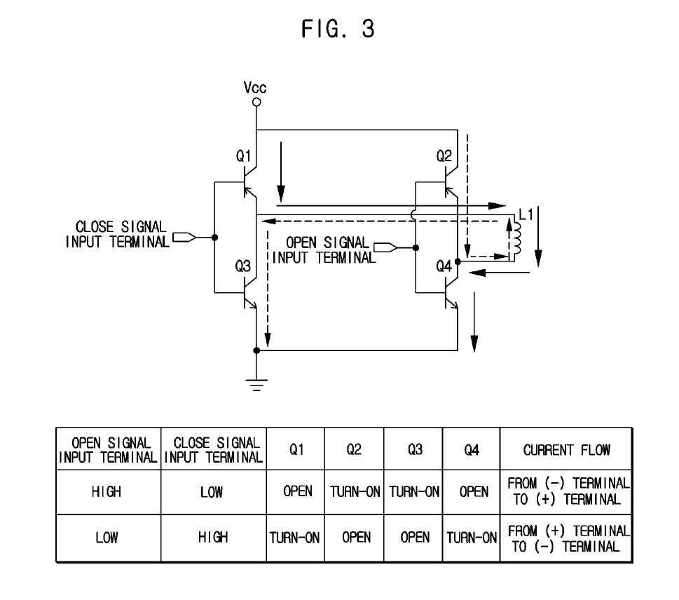

FIG. 3 is a view illustrating the configuration and operation of the door operating unit in accordance with the embodiment of the present invention. Referring to FIG. 3, the door operating unit 220 is provided with input terminals to receive the open signal and the close signal from the control unit 230, and four switches Q1, Q2, Q3, and Q4 and a solenoid L1.

Thus, in the case where a high-level signal is inputted into the open-signal input terminal and no signal is inputted into the close-signal input terminal, namely, a low level is maintained in the close-signal input terminal, the switches Q2 and Q3 are turned on, so that a current flows to the switches Q2 and Q3, whereas the switches Q1 and Q4 are opened, so that the flow of a current to the switches Q1 and Q4 is interrupted, and thus a current flowing through the solenoid flows in a direction from a negative terminal to a positive terminal. When the current flows through the solenoid in the direction from the negative terminal to the positive terminal, the door of the connector connection part of the EV charging stand is opened.

Further, in the case where a high-level signal is inputted into the close-signal input terminal and no signal is inputted into the open-signal input terminal, namely, a low level is maintained in the open-signal input terminal, the switches Q1 and Q4 are turned on, so that a current flows to the switches Q1 and Q4, whereas the switches Q2 and Q3 are opened, so that the flow of a current to the switches Q2 and Q3 is interrupted, and thus a current flowing through the solenoid flows in a direction from the positive terminal to the negative terminal. Here, when the current flows through the solenoid in the direction from the positive terminal to the negative terminal, the door of the connector connection part of the EV charging stand is closed.

Thus, the door operating unit 220 is configured to change the direction of the current flowing through the solenoid depending on the input terminal receiving the high-level signal, thus controlling the opening or closing of the door.

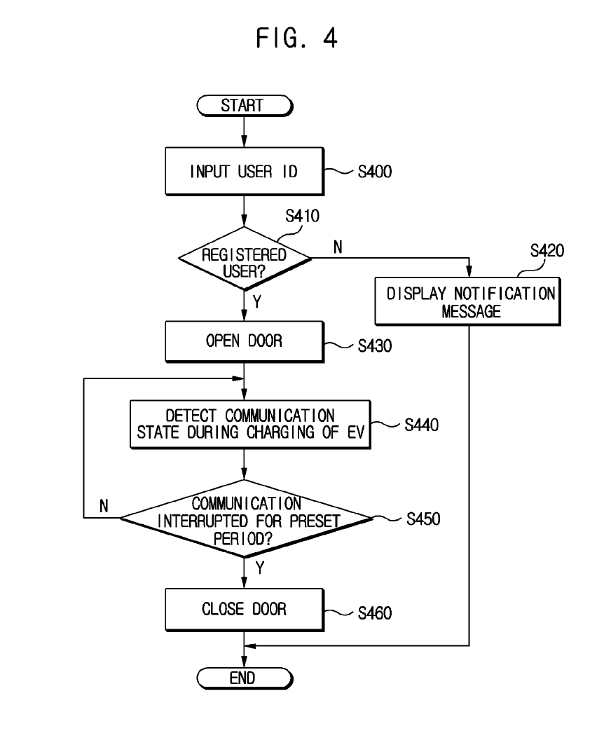

FIG. 4 is a flowchart illustrating a process of opening or closing the door of the connector connection part in the EV charging stand in accordance with the present invention.

As shown in the drawing, the apparatus receives ID information of the EV user via the user interface unit 200, at step S400. The user identification unit 210 checks whether the received ID information matches pre-registered ID information, at step S410. If the received ID information matches the pre-registered ID information, the control unit 230 transmits the open signal to the door operating unit 220, thus opening the door of the connector connection part of the EV charging stand, at step S430. In contrast, if the received ID information does not match the pre-registered ID information, the control unit 230 does not open the door and displays the notification message in the user interface unit 200 to notify that the received ID information does not match the pre-registered ID information, at step S420.

After the control unit 230 opens the door, the control unit 230 monitors the connection between the EV connector and the connector connection part of the EV charging stand, at step S440. If the communication between the connector and the connector connection part is interrupted for a preset period of time, the control unit 230 transmits the close signal to the door operating unit 220, thus closing the door, at steps S450 and S460.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for operating a door of a connector connection part in an EV charging stand, comprising:
a user interface unit configured to receive ID information of an EV user;
a user identification unit configured to check whether the received ID information matches pre-registered ID information, and to output a result of the checking;
a control unit configured to receive an output of the user identification unit, and to transmit a signal for controlling a door operating unit depending on the result of the checking; and
the door operating unit configured to switch the door of the connector connection part in the EV charging stand between an open mode and a close mode in response to the signal transmitted from the control unit.

2. The apparatus as set forth in claim 1, wherein the control unit is configured to transmit an open signal to the door operating unit, when the received ID information matches the pre-registered ID information.

3. The apparatus as set forth in claim 1, wherein the control unit is configured to display a notification message in the user interface unit to notify mismatch between the received ID information and the pre-registered ID information, when the received ID information does not match the pre-registered ID information.

4. The apparatus as set forth in claim 1, wherein the control unit is configured to monitor a connection between a connector of the EV and the connector connection part of the EV charging stand, and to transmit a close signal to the door operating unit when the connector is disconnected from the connector connection part for a predetermined period of time.

5. The apparatus as set forth in claim 1, wherein the door operating unit comprises a solenoid to change a direction of a current flowing through the solenoid in response to the signal transmitted from the control unit, thus opening or closing the door.

6. The apparatus as set forth in claim 1, wherein the control unit is configured to store information on a use of the charging stand and a charged vehicle in an internal memory.

7. The apparatus as set forth in claim 6, wherein the stored information is used for security of a vehicle.

8. The apparatus as set forth in claim 6, wherein the stored information is transmitted through a central management server to each user.
